(19) United States
(12) Patent Application Publication
(10) Pub. No.: US 2009/0090573 A1
(43) Pub. Date: Apr. 9, 2009

(54) Hybrid electric vehicle and towable trailer that uses renewable solid fuel

(76) Inventor: Daniel J. Boone, Indiana, PA (US)

Correspondence Address: Gary P. Topolosky, 4031 Brownsville Road, Pittsburgh, PA, 15227-3419, US

(21) Appl. No.: 11/906,572

(22) Filed: Oct. 3, 2007

(51) Int. Cl. B60K 6/00; B60K 6/24; B62D 59/04

(52) U.S. Cl. 180/65.245; 280/400; 903/905; 180/65.285; 180/65.29; 180/65.21; 903/906

(57) ABSTRACT

A hybrid electric vehicle having an array of batteries that recharge with a generator connected to a Stirling engine, steam engine and/or steam turbine powered by combusting a solid fuel product. The battery array for this vehicle, which is a series hybrid, can be recharged using residential electrical current. A preferred solid fuel product for burning in the generator-charging engine of this vehicle is selected from cellulose, lignin and combinations thereof, most preferably in the form of pellets or small logs.

### FIELD OF THE INVENTION

This invention relates to the field of hybrid electric vehicles. More particularly, the present invention relates to a hybrid electric vehicle using a Stirling engine, steam engine, or steam turbine fueled by cellulose combustion to recharge the vehicle's battery array.

### BACKGROUND OF THE INVENTION

Alternative transportation fuels and systems are becoming increasingly desirable. The high cost of petroleum, its decreasing and finite availability, and serious implications for the global climate from continued use of fossil fuels, are factors driving a search for other fuels for means of transportation. Independence from current sources of petroleum is also a significant geo-political factor.

One such alternative is biofuels. Both ethanol and biodiesel are being investigated as possible replacements for gasoline and diesel fuel. The advantage of both fuels is that they are producible from sustainable agricultural practices. They will contribute no additional green house gases (GHG's) and reduce dependence on imported petroleum. In addition, only minor modifications of current internal combustion engines are necessary to accommodate ethanol or biodiesel as satisfactory fuels. Despite enthusiasm for ethanol and biodiesel, there appear to be serious drawbacks to using them as the primary fuel for transportation needs. Current methods of ethanol production require the use of fossil fuels (such as natural gas for the fermentation and distillation processes). Some analyses show that it requires more fossil fuel energy to produce one gallon of ethanol than the energy that one gallon contains, with a concomitant overall increase in GHG emissions. Moreover, even if all agricultural output of suitable crops were diverted into ethanol or biodiesel production, leaving no crops for food or other uses, the most optimistic estimates are that it would satisfy at best one-half of U.S. gasoline demand. (See, for example, Scientific American, Sep. 2006, special issue on Energy's Future; Scientific American, January, 2007, “Is Ethanol for the Long Haul?” by Matthew L. Wald; Consumer Reports, October 2006, “The Ethanol Myth”; and Road & Track, November, 2006, “Fueling Our Mobility.”) These estimates note that: (i) switchgrasses or other crops might be substituted for corn or grains; and (ii) more efficient production methods may be developed, including energy inexpensive methods of extracting sugars from cellulose. Extracting cellulose sugars permits production facilities to use the stalk, leaves, and whole plant, rather than just the grain, fruit, or high sugar content plant juices.

The U.S. does not have the climate and terrain of Brazil, for example, which can grow sufficient sugar cane (having four times the amount of sugar as corn) to meet its own demands for transportation fuel. Cellulose sugar holds much promise, but efficient technologies to make this a reality are still in development, requiring major biochemical innovations. And experts believe that supply will never meet demand. Thus, the consensus of most experts is that ethanol and biodiesel alone will never satisfy the needs for transportation fuel.

Another alternative being explored enthusiastically by automakers and others is fuel-cell technology, which uses hydrogen as a fuel. There are many advantages to using hydrogen to fuel our cars, including more efficient engines, quieter and better performance, lower maintenance, cleaner emissions (only water vapor is discharged from the vehicle). Also attractive is the potential of hydrogen production from totally renewable energy sources-splitting water by electricity generated from hydroelectric, geothermal, tidal, solar or wind. Unfortunately, there remain formidable problems which make fuel-cell vehicles a dream of the distant future. These include: (1) the development of practical vehicle hydrogen storage systems so that a vehicle may safely carry an adequate supply of hydrogen for a reasonable range of around 300 miles; (2) improving the proton-exchange membrane so that fuel-cells are more durable and have a small enough weight and size to fit in passenger cars; (3) solving the distribution problem of making hydrogen fuel widely available to the consuming public, as is now the case with ordinary gas stations; and (4) addressing the safety issues connected with using and distributing such a highly explosive and flammable fuel as hydrogen. Making the necessary changes in infrastructure to make a changeover to hydrogen-fueled vehicles will be an additional problem even when breakthroughs occur in these other areas. Estimates are that it will take decades before a hydrogen-based transportation system using only completely renewable resources could become a reality. (For further discussion of the serious challenges facing automotive fuel-cell technology, see Sunita Satyapal, John Petrovic, and George Thomas, “Gassing Up with Hydrogen,” Scientific American, April, 2007.)

Electric cars are another possible alternative. Using plug-in vehicles that may be recharged at residential sites allows the use of much cheaper electricity from the electric grid, with a potential for generation by renewable resources. Good performance, quiet operation, and no emissions are standard features of already commercially available electric cars. Unfortunately, electric vehicles have a serious limitation. Today's batteries are heavy and to put enough on board for even moderate driving distances makes the vehicles bulky and inefficient. Improving battery technology presently seems insurmountable and has led many auto manufacturers to abandon a mostly electric car option. Hybrid electric cars address this problem by including a gas engine onboard to recharge the batteries. Of course, ethanol or biodiesel engines could be used as a gas engine alternative though no current automakers offer that option. Even with the improved mileage of hybrids, this is a stop-gap remedy at best. There will still be a dependency on petroleum or biofuels with all the attendant problems described above.

It is therefore desirable to have a vehicle powered by a fuel which: (1) is from a completely renewable resource; (2) is in adequate supply to meet future consumer demand; (3) does not require developing new sophisticated technologies; (4) runs a vehicle that has the performance, size, and weight of current automobiles; (5) is safe to carry onboard and may be safely, yet easily distributed at refueling stations conveniently accessible to consumers; (6) will not contribute to GHG emissions; and (7) is cheaper to produce than fossil fuels or biofuels.

The present invention achieves these objectives through the design of a hybrid electric vehicle. The batteries are recharged by a generator run by a Stirling engine, steam engine, or steam turbine. The heat powering the Stirling or steam engine/turbine is created by a combustion device that burns pellets or small logs made from cellulose or lignin. Cellulose or lignin may be produced from a wide and abundant variety of sources, especially agricultural and forestry waste. Alternatively, special crops may be grown for this purpose. The present invention uses minimal processing to yield a solid burnable fuel derived from whole plants rather than the sophisticated processing required to produce fuels for internal combustion engines from just plant sugars. Combustion substantially occurs in a stove or firebox, and at ordinary atmospheric pressures rather than the high pressures in today's internal combustion engines. Thus, the noxious emissions typically associated with gasoline or diesel engines are not produced. Carbon dioxide is the primary emission of such a system. However, because the fuel is obtained from renewable crops, the net carbon footprint will be zero.

Steam engines are well-known in the art. U.S. Published Application No. 20030005700 describes running a steam engine from a wood stove to generate electricity for residential use. However, it does not claim nor make obvious applications for a hybrid electric vehicle. U.S. Published Application No. 20020153178 claims a hybrid electric vehicle with batteries that recharge with wind generators from the flow of air when the vehicle is moving. The system further includes braking generators, solar generators, and a back-up steam turbine fired by propane. However, it does not claim a steam engine or steam turbine as a primary electrical generation method. Further, it does disclose or claim a cellulose- or lignin-fired combustion chamber as the heat source.

The preceding published application is only one of many which purport to recover electricity with wind generators activated by vehicular air flow. See also, U.S. Pat. Nos. 5,296,746, 5,584,355, 5,760,515, 5,746,283, 5,680,032 and 5,920,127. In principle, the applications are limited because the wind resistance created by such generators must be overcome which will require additional power to keep a vehicle moving at constant speeds. Given the inefficiencies of turning an electric generator, it would always require more electrical energy to: (a) keep the vehicle moving at the same speed; and (b) overcome the increased wind resistance generated by tapping into that air flow. Otherwise, one might have a “perpetual motion” vehicle.. The only way such a generator might work with some efficiency would require positioning the same in a vortex of air flow behind the vehicle. In this position, the generator might not create resistance to the vehicle's forward motion. Unfortunately, the sensors and positioning devices that would be needed to keep the wind rotor in such a “sweet spot” (if one exists) might prove too costly and inefficient.

Stirling engines of suitable generating capacity have been developed as research prototypes. U.S. Pat. No. 5,335,497 claims a rotary Stirling engine that depicts a design that unfortunately has typical sealing problems. Further, that invention uses “liquid fossil” or “gaseous” fuels. Moreover, nothing in the patent discloses or suggests that the system could be installed in a hybrid electric vehicle.

Other modifications to the basic Stirling concept of an external combustion engine, such as Siemans and Rinia engines and several different designs by Sunpower, Inc., are known. Stirling engines may be simpler to operate than a steam engine or steam turbine because they require no water or other working fluid other than air. However, steam power exploits the phase change from liquid to gas for a working fluid. This may result in a more efficient utilization of BTUs from the heat source than what otherwise occurs in the heating/cooling cycle of a Stirling engine.

Numerous patents have described a hybrid electric vehicle in which an internal combustion engine recharges the battery array and/or provides some motive power to the vehicle. See, for example, U.S. Pat. Nos. 3,792,327, 6,554,088 and 7,104,347. But because internal combustion engines require fossil or biofuels, they are still subject to the same problems and limitations described above. Unlike the present invention, no invention that uses an internal combustion engine satisfactorily addresses today's serious environmental, resource limitation, and geo-political issues.

U.S. Pat. No. 5,176,000 claims a steam or “fluid” turbine that derives heat from an internal combustion engine to generate electricity in a hybrid electric car. However, the turbine serves only as an auxiliary means for battery recharging. The internal combustion engine of that invention is the main recharging system. It also supplies motive power to the vehicle. That invention does not use or disclose non-fossil renewable fuels as the primary means for recharging a battery array.

U.S. Published Application No. 20050052080 claims an “adaptive” hybrid electric car” with an auxiliary recharging engine selected from a gasoline internal combustion engine, a steam engine and a turbine engine. Hydrogen fuel cells are also claimed in one configuration, although it is unclear whether such fuel cells recharge the batteries or merely provide electricity to an electric motor. Regardless, nothing in that application suggests powering a steam or turbine engine with anything other than fossil fuels. In U.S. Published Application No. 20020153178, propane use is mentioned in such a context. However, using cellulose or lignin as the fuel for an engine is not disclosed. Furthermore, the invention does not use a Stirling engine to generate electricity.

U.S. Pat. No. 5,172,784 discloses a hybrid electric vehicle that utilizes a Stirling or other external combustion engine to burn a pollution-free fuel such as natural gas, propane or alcohol. Nowhere does this reference contemplate a solid fuel source from cellulose logs or pellets. In FIG. 1 of that patent, a liquid or gas fuel tank (21) connects by a long fuel line to a “governor/processor 23” for regulating fuel flow to the Stirling engine cylinders, around which combustion presumably occurs. With small diameter fuel lines, this system could only work with fuels in a liquid or gaseous form. Because this patent requires using fossil fuels (natural gas or propane) or ethanol, it does not address the environmental and/or resource problems discussed above. Furthermore, the vehicle design makes a Stirling engine the primary motive power source, i.e., most of the power to an electric drive motor must be created by linear generators in a free-piston Stirling engine. An auxiliary battery pack purports to provide additional power for “acceleration and hill climbing.”

An important distinction exists between a “serial” and “parallel” hybrid vehicle design. In a pure “serial” design, the electric motor powers the vehicle and the secondary engine is only used for battery recharging. A “parallel” hybrid, by contrast, uses the secondary engine for both some motive power and for battery recharging. Some vehicles combine both approaches. For instance, currently sold versions of Toyota's Prius and Camry are fundamentally parallel hybrids. However, because they can run on either the internal combustion engine or the electric motor alone, they are sometimes referred to as “series-parallel” hybrids.

Above U.S. Pat. No. 5,172,784 conceived of a “parallel” hybrid design with three Stirling engines providing electric power directly to the drive motors and a fourth Stirling engine providing current to recharge an auxiliary battery. The balance of power between the Stirling engines (3 to 1) was weighted heavily in favor of the Stirling power going directly to the vehicle's drive motor. Skepticism for that design exists in view of General Motors experiences with a Stirling driven vehicle in the 1970's. Stirling engines are balky and unresponsive to sudden and quickly changing demands for increased power, such as hill-climbing and acceleration. The demands placed on an auxiliary system in typical stop-and-go city driving, or hilly, mountainous driving, would likely be constant and excessive. The higher fuel efficiencies and reduced battery dependency claimed in that patent may not be realizable under most actual driving conditions, especially because its design allows for variable fuel injection rates which always lag behind highly variable power demands.

By contrast, the present invention is more of a purely “series” hybrid. Using a serial hybrid configuration allows the Stirling or steam engine/turbine to be low horsepower, more compact, and run at speeds for optimal fuel efficiency, a decided size and weight advantage for automotive applications. There will be no need to radically vary fuel input depending on driving conditions. Moreover, the electric drive motors of this invention can be sufficiently sized and powered to meet all demands for acceleration and hill-climbing. The use of a totally renewable solid cellulose fuel, instead of any liquid or gaseous fossil or biofuel, allows the present invention to address the serious environmental, supply, and geo-political problems today's transportation systems now face.

Thus, there is a clear need for a hybrid electric vehicle that runs on a substantially renewable, plentiful, and inexpensive fuel like cellulose or lignin.

### BRIEF SUMMARY OF THE INVENTION

The present invention is a hybrid electric vehicle with batteries that can recharge by access to a standard residential current. In addition, the vehicle will carry on board a Stirling engine, steam engine, or steam turbine engine to run an electric generator for recharging the batteries while the vehicle is running. Such a design accommodates a smaller battery array while extending the overall driving range of the vehicle. The heat source for the Stirling or steam engine variant is a “whole plant” combustion device that can use as its fuel: (a) cellulose or lignin pellets; (b) small logs derived from forestry or agricultural growth; or (c) forestry or agricultural waste such as cornstalks, corn cobs and husks, grain straws, grasses, and wood chips. Oils and sugars, or other plant materials, need not be removed from such fuel sources because they provide energy in combustion. They can, however, be extracted for other uses. Other potential fuel sources include recycled paper or cardboard, or waste sources of cellulose or combustible materials like those readily found from building construction, landscaping operations, paper mill residues, residential lawn and garden waste product, unrecyclable office paper waste and non-consumables from the food industry. The fuels for this invention can be made from a source that: (a) will burn cleanly; (b) is a large and inexpensive resource; and (c) processes into a final fuel product without sophisticated fermentation, distillation and/or biomass conversion. If a cellulose fuel is made from a renewable resource, with any carbon dioxide emissions balanced by growth of replacement crops, the carbon footprint from GHG's will be a net zero. If commercially viable methods are developed for distilling ethanol from cellulose, the remaining byproduct of lignin could also serve as fuel.

The main power train of this vehicle is an electric motor with the Stirling or steam engine/turbine serving only to recharge the batteries for same. As such, this invention would be configured as a “serial” hybrid as described above. Although Stirling engines, steam engines, or steam turbines typically lack the quick responsiveness of an internal combustion engine, making them less suitable for providing highly variable motive power, in a true serial design, that disadvantage can be overcome by making the electric drive motor the only source of motive power. In addition, for shorter distance trips within the battery array's capacity, the Stirling or steam engine/turbine need not be employed. Fuel in the form of pellets or small logs is not explosive or highly flammable. It can be easily transported and stored, or easily transferred to individual vehicles in a mechanical, metered way. Finally, the ash and other combustion byproducts can be recycled as a fertilizer component for growing renewable crops and produce even more fuel sources.

### BRIEF DESCRIPTION OF THE DRAWINGS

FIG. 1 is a partial schematic, side perspective view of a vehicle with one embodiment of the invention incorporated therein;

FIG. 2 is a front view schematic of a combustion chamber with two free-piston Stirling engines mounted on opposed sides in a position that most efficiently captures heat from the combustion.

FIG. 3 is a partial schematic, side perspective view showing components similar to those in FIG. 1 mounted on a movable attachment.

FIG. 4 is a partial schematic, side perspective view of a second embodiment of this invention with a boiler coil in the combustion chamber driving a condensing impulse steam turbine to generate electricity.

### DETAILED DESCRIPTION OF PREFERRED EMBODIMENTS

Aspects of select components of the present invention already exist, albeit in crude forms, that may require substantial revision. For example, a standard wood pellet stove may drive a small off-the-shelf steam engine, steam turbine, or Stirling engine, to run an electric generator for recharging the batteries of a commercially available electric car like the Tango. Such a recharging system could be installed on a small trailer, for towing behind a vehicle for trips beyond the normal battery driving range; but not included on shorter trips that do not exhaust the battery's driving range. A preferred fuel source, wood pellets, can be purchased at many locations. Some wood pellet stoves make use of an automatic-feed, thermostatically-controlled hopper that only needs occasional refilling. Thus, the present invention can be integrated in the existing transportation system. Although improvements and refinements are desirable, the technological challenges posed by integrating the present invention in the current transportation system are much less daunting than the challenges presently facing biofuel development, hydrogen fuel-cell systems, or creating more efficient batteries. Some of desirable improvements include: (a) innovating a compact, efficient, and safe Stirling engine, steam engine and/or steam turbine suitable for vehicle installations; (b) an energy-efficient production of clean-burning cellulose pellets or logs from such renewable sources as agricultural or forestry products or waste and waste cellulose in any form; (c) developing efficient, safe, and consumer-friendly pellet or log combustion devices with automatic fuel feeders; (d) designing screen, “scrubbing” or catalytic converter devices to remove smoke, ash, particulates and other exhaust emissions sufficient to ensure conformity with the emission requirements of all states; (e) developing a system that safely and conveniently removes ash and solid combustion products from the vehicle for disposal elsewhere; and (f) implementing a system for making pellet or log fuel distribution readily available and conveniently transferable to consumer vehicles. With respect to above item (d), the carbon footprint should not be a problem if cellulose fuels are derived from only totally renewable sources. Thus, carbon dioxide emission controlling may seem unnecessary although it may still be preferred to remove typical wood smoke pollutants from traffic environments because of their potential offensive odor. One can imagine a traffic jam in a tunnel surrounded by vehicles emitting ordinary wood smoke. On the other hand, a properly burning wood stove will not normally emit as much carbon monoxide or nitrogen compounds as (and may be less obnoxious than) the exhaust fumes from the poorly tuned diesel bus or truck engine.

There are presently few, if any, laws that prohibit the residential use of wood stoves or fireplaces. As wood stove emissions are of a rather different nature than the exhaust from internal combustion vehicles, current vehicle emissions statutes may not apply to vehicle emissions from the present invention. If they do, or are amended to, apply, the present invention will have to be engineered to conform to such statutes; a challenge, but not an especially formidable one. Assuring a cellulose fuel supply that is sulfur-free and burns cleanly should solve most of the problem.

One embodiment of this invention will run on ordinary wood fuel or other agricultural waste products like corn stalks burned in a conventional wood stove. Although more inconvenient to run with no automated fuel-feed and/or ash-removal, it may be preferred in remote areas with an abundant supply of unprocessed fuel. In those locales, the vehicle of this invention may be used for transportation and some supplemental supplying of electricity.

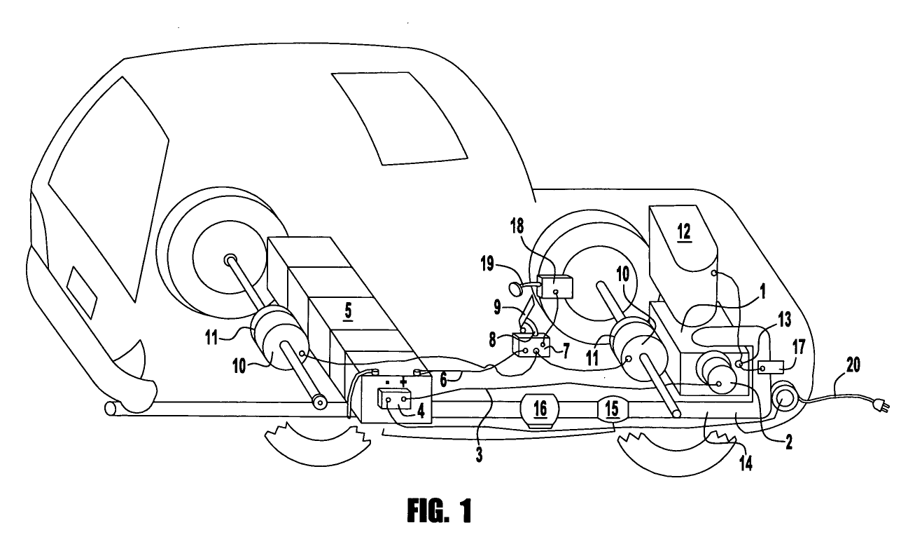

FIG. 1 depicts a side perspective view, slightly angled from above and behind, with the front of a vehicle on the right. The combustion chamber 1 therein is used for burning cellulose or lignin pellets or small logs. Two or more free-piston, Stirling engines 2 (only one is shown) with integrated linear electrical generators are mounted on opposed sides of the combustion chamber in a position that most efficiently captures the heat from combustion. The Stirling engines are connected by means 3 to a charge controller/regulator/inverter 4 that recharges the battery array 5. The battery array is connected 6 to an appropriate electric power regulator 7 primarily controlled by inputs from an accelerator sensor 8 attached to the accelerator pedal 9. The accelerator-controlled regulator 7 delivers controlled electric power by suitable connections to the two or more drive motors 10. Continuously variable computer-controlled transmission devices 11 with reverse controls attached to each axle permit driving the vehicle in different “gears,” a free-wheeling mode, as well as in reverse.

A storage bin 12 holds cellulose fuel preferably in the form of small rectangular cellulose or lignin logs packaged for simple delivery from an outside refueling hatch. The fuel storage bin 12 is positioned over the combustion chamber 1 permitting the automatic delivery of cellulose logs given inputs from a temperature sensor/regulator 13 in the combustion chamber. Electrical ignition devices in the firebox (not shown) ignite these cellulose logs when delivered.

Exhaust from the combustion chamber is routed through an exhaust pipe 14 having ash and particulate filtering 15 and electrostatic 16 components for removing combustion products in the exhaust pipe. A draft control fan system 17, controlled by a combustion chamber temperature sensor 13, ensures a sufficient draw of air through the combustion chamber. A brake regulator 18 is attached to a brake pedal 19, and is connected by suitable means to the accelerator regulator 7 and other system parts to permit regenerative braking with the drive motors 10. A retractable electric cord 20 permits plugging the vehicle into a 110 AC circuit for recharging battery array 5.

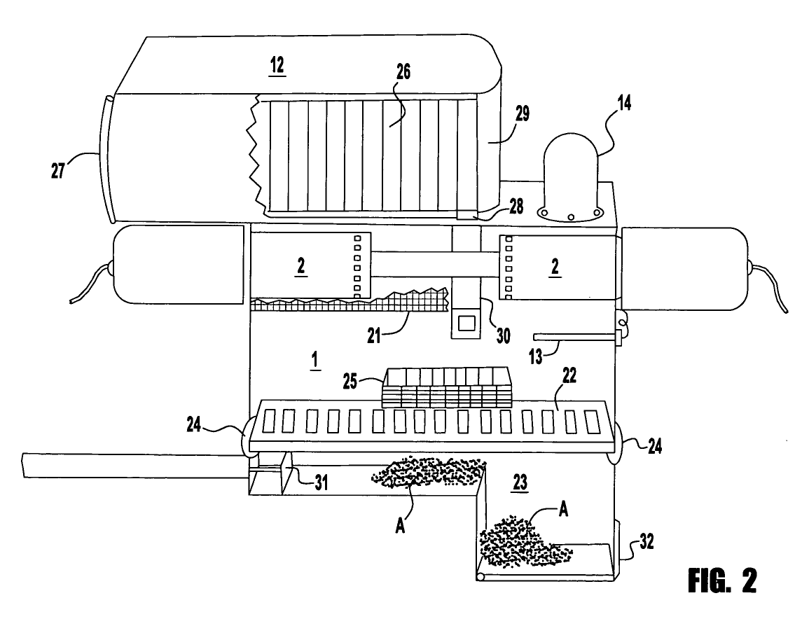

FIG. 2, is a cutaway front view of the inside of the combustion chamber from FIG. 1 shown angled and from slightly above. Therein, combustion chamber 1 has two free-piston Stirling engines 2 mounted opposed in the sides of the combustion chamber with heat expansion sides connected for phase synchronization. The engines are placed in a position that most efficiently captures heat from the combustion. Each Stirling engine has an integrated linear electrical generator. A heat-capturing grid 21 (partially shown) is positioned to carry additional heat to the heat uptake components of the Stirling engines. The combustion grate 22 has openings for permitting ash (A) to drop through into an ash holding chamber 23. They also let outside air from the air intakes 24 flow through the grate. An electrical ignition coil 25 is positioned above the grate to ignite the cellulose logs or pellets. In this view, the fuel storage bin 12 is shown partially cutaway holding stacks of small cellulose logs 26. Packages of such logs may be fed into that bin through fuel delivery hatch 27. Openings in the bottom of the bin 28 and mechanical means for pushing logs into the combustion chamber 29 are controlled by a temperature sensor/regulator 13. That component regulates the flow of fuel logs into the combustion chamber. The fuel logs enter the combustion chamber through a delivery tube 30. The exhaust pipe 14 carries away gaseous combustion products. The ash holding chamber 23 has mechanical means 31 for pushing ash into the removal bin and other mechanical means for lowering ash removal hatch 32. Ideally, such ash removal devices should only be operated at appropriate ash removal sites.

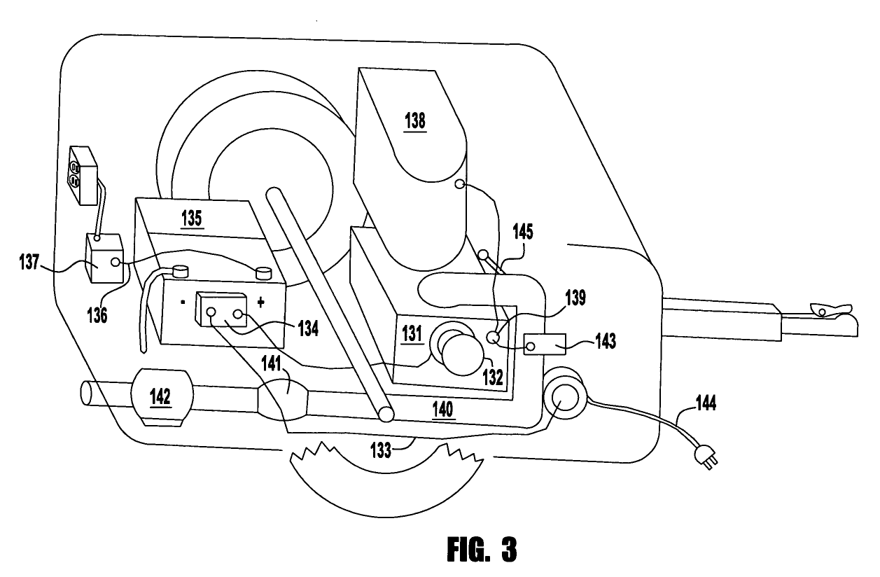

In FIG. 3, components like those shown in FIG. 1 are mounted on a movable attachment, shown as a representative trailer that may be towed or otherwise transported behind a vehicle. The movable attachment is shown in a side view cutaway schematic, from a slightly angled perspective, above and behind, with the front of the movable attachment to the right of this Figure. The combustion chamber 131 is used for burning cellulose or lignin pellets or small logs. Two or more free-piston Stirling engines 132 (only one is depicted) with integrated linear electrical generators are mounted on opposed sides of the combustion chamber in a position that most efficiently captures heat. The Stirling engines are connected by means 133 to a charge controller/regulator 134 for recharging battery array 135. That array 135 is connected 136 to an appropriate electric power inverter 137 with electrical outlets for providing either 110 or 220 AC current.

A storage bin 138 holds cellulose fuel, preferably in the form of small rectangular logs packaged for facile delivery thereto through an outside refueling hatch. The fuel storage bin 138 is positioned over the combustion chamber 131 permitting the automatic delivery of cellulose logs based on inputs from a temperature sensor/regulator 139 in the combustion chamber. Electrical ignition devices in the firebox (not seen) ignite the cellulose logs after delivery. Exhaust from the combustion chamber is routed through an exhaust pipe 140 with ash and particulate filtering 141 and other electrostatic components 142 for removing combustion products from the exhaust pipe. A draft fan system 143, controlled by temperature sensor/regulator 139, ensures sufficient air draw through the combustion chamber. A retractable electric cord 144 permits a trailer embodiment to be plugged into a typical 110 AC circuit, also for recharging the battery array 135. An alternative fuel door 145 (seen partially open) is accessible from the trailer front. It permits the use of ordinary firewood or other combustibles.

The movable attachment/trailer of FIG. 3 may be towed behind a standard plug-in electric vehicle and/or modified so that its plug-in capabilities can recharge a vehicle battery even while being driven. This will extend the driving ranges of such vehicles. Alternatively, such a trailer can be towed from behind a vehicle and provide on-site electric power using available combustible fuel.

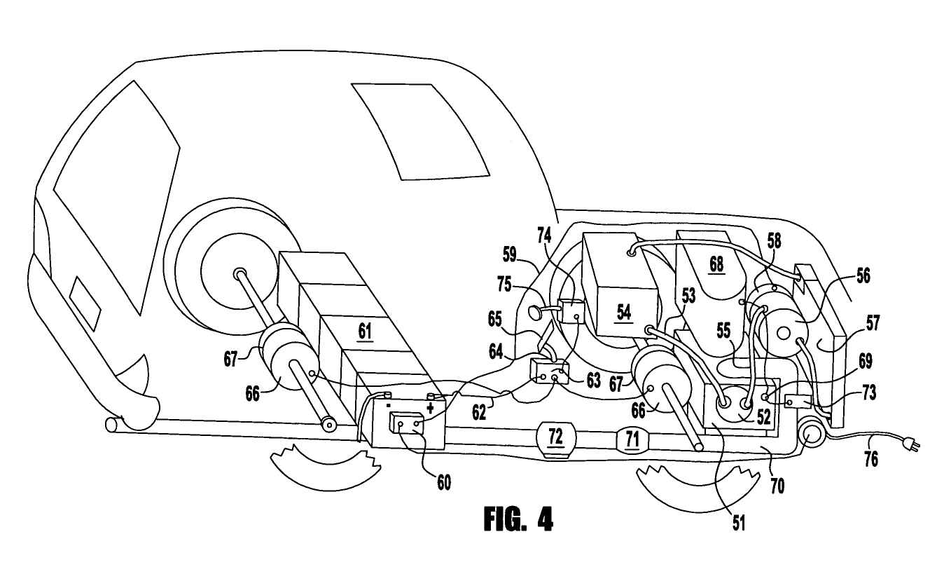

The combustion chamber 51 of FIG. 4 can also be used to burn cellulose or lignin pellets or small logs. A boiler coil 52 in the combustion chamber has a water input pipe 53 from a water storage tank 54 and a steam output pipe 55 leading to a condensing impulse steam turbine 56. Exhaust steam from the turbine passes through a condenser 57 and the cooled water returns to water storage tank 54. The steam turbine 56 from this embodiment runs an electric generator 58. Suitable control, bypass and safety valves, as well as known pumps and speed regulators, may be included in this system. The electric generator 58 is connected by means 59 to a charge controller/regulator 60 that recharges the battery array 61. That battery array is connected 62 to an appropriate electric power regulator 63 primarily controlled by inputs from an accelerator sensor 64 attached to accelerator pedal 65. That regulator 63 delivers controlled electric power by suitable connections to two or more drive motors 66. Some form of continuously variable computer-controlled transmission device with reverse controls 67 attaches to each drive axle permitting the vehicle to be driven in different “gears,” a free-wheeling mode, as well as in reverse.

In FIG. 4, a fuel storage bin 68 holds small rectangular cellulose or lignin logs packaged for simple delivery through an outside refueling hatch. The fuel storage bin 68 is positioned over the combustion chamber 51 permitting the automatic delivery of fuel logs based on inputs from a temperature sensor/regulator 69 in the combustion chamber. Electrical ignition devices in the firebox (not seen) ignite these logs once delivered. Exhaust from the combustion chamber will be routed through exhaust pipe 70, ash and particulate filtering 71 and electrostatic components 72 for removing combustion products in the pipe. A draft control fan system 73, controlled by temperature sensor 69, provides for the sufficient draw of air through combustion chamber 51. A brake regulator 74, attached to the brake pedal 75, connects by suitable means to the accelerator regulator 63 and other system parts to permit regenerative braking with drive motors 66. A retractable cord 76 allows battery array recharging by plugging the vehicle into a standard 110 AC circuit.

The placement and relative size of the various components in the drawings are approximate. Safety considerations may require adding insulated, fireproof, and crash-proof baffles around the combustion chamber and engines.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention.

What is claimed is:

1. A hybrid electric vehicle having an array of batteries that can be recharged with a generator connected to an engine selected from a Stirling engine, a steam engine and a steam turbine, said engine powered by combusting a solid fuel product.

2. The hybrid electric vehicle of claim 1, wherein said solid fuel product is from a renewable resource.

3. The hybrid electric vehicle of claim 1, wherein said solid fuel product is in the form of pellets or small logs.

4. The hybrid electric vehicle of claim 3, wherein said solid fuel product includes cellulose.

5. The hybrid electric vehicle of claim 3, wherein said solid fuel product includes lignin.

6. The hybrid electric vehicle of claim 1, wherein said solid fuel product includes waste product selected from the group consisting of: forestry waste, agricultural waste, landscaping waste, food products, paper recyclables and combinations thereof.

7. The hybrid electric vehicle of claim 1 which is a series hybrid.

8. The hybrid electric vehicle of claim 1, wherein said battery array can also be recharged using residential electrical current.

9. The hybrid electric vehicle of claim 1, wherein said engine is housed on the vehicle and operates while the vehicle moves.

10. The hybrid electric vehicle of claim 1, wherein said engine is housed in an attachment to the vehicle.

11. The hybrid electric vehicle of claim 1, wherein a by-product of said engine can be used in a fertilizer.

12. A hybrid electric vehicle having an array of batteries that can be recharged with a generator connected to an engine housed on the vehicle and powered by combusting a solid fuel product in the form of pellets or small logs.

13. The hybrid electric vehicle of claim 12, wherein said engine is selected from the group consisting of at least one: Stirling engine, steam engine and steam turbine.

14. The hybrid electric vehicle of claim 12 which includes a plurality of solid fuel-powered Stirling engines.

15. The hybrid electric vehicle of claim 12 which further includes a container housed on the vehicle for storing excess solid fuel product and a mechanism for transmitting said solid fuel product from said container to said engine.

16. The hybrid electric vehicle of claim 12 which is a series hybrid.

17. The hybrid electric vehicle of claim 12, wherein said battery array can also be recharged using residential electric current.

18. The hybrid electric vehicle of claim 12, wherein said solid fuel product includes cellulose, lignin and combinations thereof.

19. A movable attachment engaged behind a hybrid electric vehicle having an array of batteries that can be recharged from a generator powered by one or more engines in said movable attachment that combusts a solid fuel product, said engine selected from the group consisting of a Stirling engine, a steam engine and a steam turbine engine.

20. The movable attachment of claim 19, wherein said engine burns pellets or small logs made from cellulose, lignin and combinations thereof.
